(19) United States
(12) Patent Application Publication
(10) Pub. No.: US 2017/0358046 A1
(43) Pub. Date: Dec. 14, 2017

(54) PROGRESS TRACKER OF CANDIDATES IN ADMISSIONS CYCLE FOR SCHOOLS

(71) Applicant: Chegg, Inc., Santa Clara, CA (US)

(72) Inventors: Rahul Ravindra Mutalik Desai, San Jose, CA (US); Fei Sha, Santa Clara, CA (US); Ben Van Roo, Santa Clara, CA (US); Seth Kadish, Santa Clara, CA (US); Dax Eckenberg, Los Gatos, CA (US); Michael Osier, Santa Clara, CA (US); Jason Schnitzer, Santa Clara, CA (US)

(21) Appl. No.: 15/178,147

(22) Filed: Jun. 9, 2016

(51) Int. Cl. G06Q 50/20; G06F 17/30

(52) U.S. Cl. CPC G06Q 50/2053; G06F 17/3053

(57) ABSTRACT

An admission cycle progress tracking system and method updates candidate ranking of a candidate at a particular school based on its advancement at a different school. The admission cycle progress tracker receives a candidate qualifier of a candidate at a first school. The candidate qualifier indicates the candidate's progress in the admission cycle of the first school. The admission cycle progress tracker receives a candidate qualifier of a candidate at a second school. The candidate qualifier indicates the candidate's progress in the admission cycle of the second school. Further, the candidate's advancement within the admission cycle of the first school is determined based on the candidate qualifier. Responsive to the determination of advancement at the first school, the ranking and the candidate qualifier of the candidate are updated at the second or other schools on which the candidate is listed.

### BACKGROUND

This invention relates generally to tracking progress of a candidate within admission cycle of schools, and more particularly to tracking and adjusting a position of a candidate at a school based on their progress at other schools.

### SUMMARY

An admissions cycle progress tracker tracks the progress of each candidate within the admissions cycle of schools. A school has a list of potential candidates that may be admitted to the school or are interested in being admitted to the school for a specific academic year. The potential candidates may be ranked within the potential candidate list of each school, based on their academic attributes such as their interest in the school, academic records and other such attributes. A candidate can be on the potential candidate lists of more than one school prior to being enrolled in a school.

The admissions cycle progress tracker receives a candidate qualifier (i.e. information related to a candidate's progress in the admission cycle of a school) for each candidate on the potential candidate list for a school. The candidate qualifier information identifies the status of the candidate's progress within the admission cycle of that school. Typical qualifiers include “prospect,” “interested,” “inquired,” “applied,” “admitted,” “enrolled,” or “confirmed.” If a candidate qualifier indicates that the candidate has “applied” to the school, the natural progression of the candidate will be to either receive an admission offer from the school or a rejection offer from the school. For each candidate in the potential candidate list of a school, the admissions cycle progress tracker retrieves a candidate qualifier. The admissions cycle progress tracker further tracks the status of the candidate's progress within the admission cycle of another school, based on the candidate qualifier of the candidate at the other school.

The admission cycle progress tracker determines that the candidate has advanced in the admission cycle of the first school as indicated by the candidate qualifier of the first school. For example, the candidate qualifier at the first school changes from “admitted” to “enrolled.” Based on the determination of advancement, the admission cycle progress tracker updates the candidate qualifier of the candidate, at the second school. Additionally, the admission cycle progress tracker updates the ranking of the candidate within the potential candidate list of the other school. For example, if the candidate qualifier indicates that a candidate has “confirmed” admission at the first school, the candidate may be removed from the potential candidate list of the other schools. Another example, if the candidate qualifier indicates that a candidate has “enrolled” at the first school, the candidate may be pushed to a lower ranking at the other schools, or the candidate qualifier at the other schools may be updated to “admitted.”

### BRIEF DESCRIPTION OF THE DRAWINGS

FIG. 1 illustrates the environment of an online admissions platform, according to one embodiment.

FIG. 2 is a diagram of functional components of an admissions cycle progress tracker for schools, according to one embodiment.

FIG. 3 is a diagram of an admission cycle time line, according to an embodiment.

FIG. 4 is a flow chart illustrating the method for tracking a candidate's progress within admissions cycle of schools, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Environment of an Online Admissions Platform

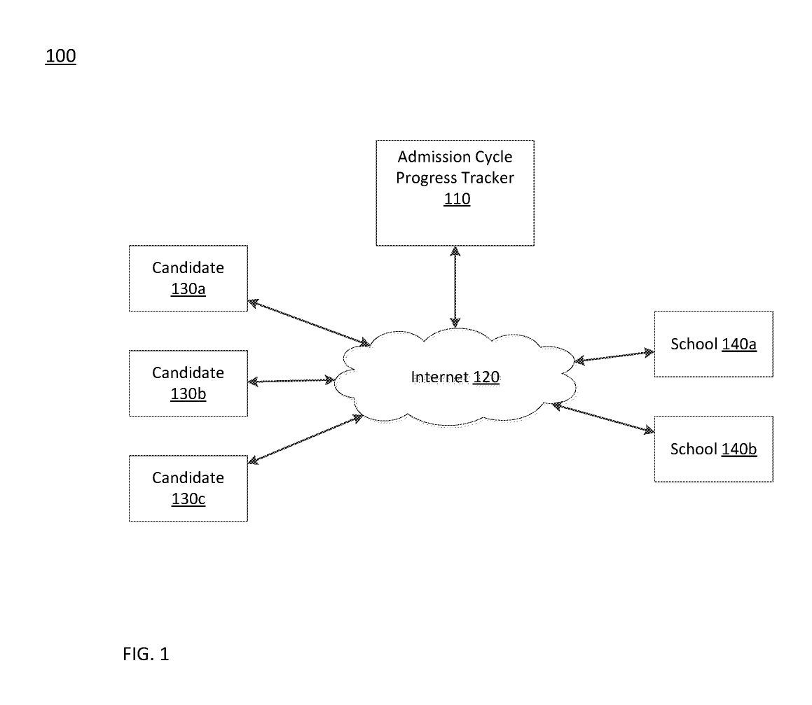

FIG. 1 is a diagram illustrating the environment of an online admissions platform, according to one embodiment. The environment 100 of the platform includes an admissions cycle progress tracker 110. The admissions cycle progress tracker 110 includes both a business-to-consumer (B2C) and business-to-business (B2B) components and is configured to adjust a position of a candidate in an admission cycle for schools seeking to enroll students in the courses offered by the school (as will be described in detail later). The admissions cycle progress tracker 110 is connected via the Internet 120 to candidates 130 and schools 140. The admissions cycle progress tracker 110 is also connected via the Internet 120 to schools 140. Candidates 130a, 130b, and 130c and schools 140a and 140b are purely for example; the admissions cycle progress tracker 110 could simultaneously support thousands or even millions of candidates 130 and hundreds or thousands of schools 140.

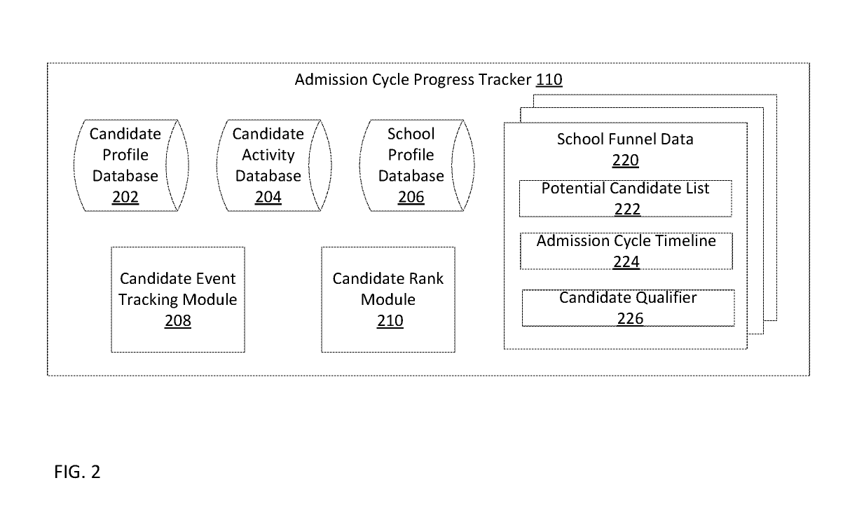

FIG. 2 is a diagram of functional components of an admissions cycle progress tracker for schools, according to one embodiment. The admission cycle progress tracker 110 includes a candidate profile database 202, a candidate activity database 204, a school profile database 206, a candidate event tracking module 208, a candidate rank module 210 and a school funnel data 220 for each school 140. The school funnel data 220 further includes a potential candidate list 222, funnel segments 224 and candidate qualifiers 226.

The candidate profile database 202 is configured to store a collection of candidate profiles. Each candidate profile is a compilation of information pertaining to a particular candidate 130. This information could be personal (location, race, gender, etc.) or academic (previously completed courses, grades, academic interests, etc.). In one embodiment, each candidate profile is composed from information inputted by a candidate 130 via the online admissions platform 100.

The candidate activity database 204 is configured to store a record of candidate activities. In some embodiments, candidate activities include an expression of interest made by a candidate 130 toward a particular school 140. The expression of interest could be expressed as a like, comment, or subscription (for example, to an RSS feed) made in the context of an online recruiting platform. Additional candidate activities include accepting an admission offer from the school 140. In one embodiment, the candidate profile database 202 and candidate activity database 204 are consolidated into a single database.

The school profile database 206 is configured to store a collection of school profiles. Each school profile contains information describing a participating school, such as its location, selectivity, class size, disciplines/degrees offered, athletic programs, and so on. In one embodiment, a school profile includes information entered by a school administrator or admissions officer via an interface of the online admissions platform. School profile information may also be compiled or aggregated from sources that are publicly available on the Internet, such as on forums, blogs, and other websites.

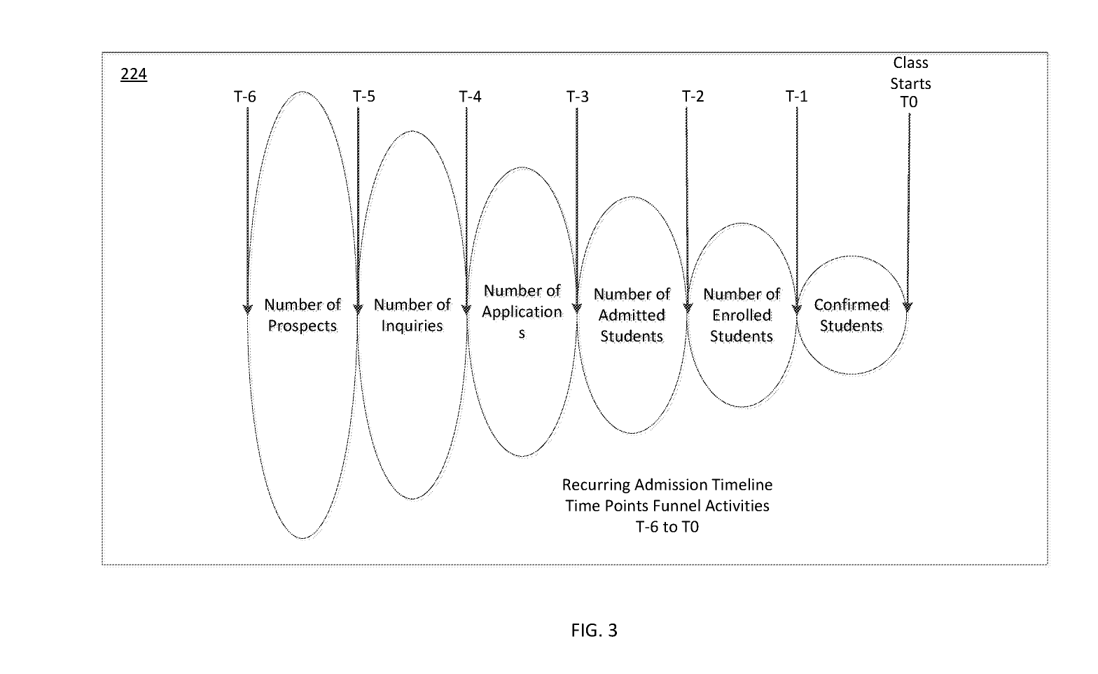

The school funnel data 220 is configured to include data related to past and current admissions cycle 224 for a school 140. An admission cycle for a school 140 includes time points that occur before a class starts and an activity corresponds to each time point. An admission cycle is explained in detail with respect to FIG. 3 below. As a part of the funnel data 220, each school includes a potential candidate list 222. A potential candidate list 222 includes a list of candidates of potential interest to a participating school, as a part of school admissions. The candidates in the potential candidate list 222 are ranked based on matching class requirements for a school to candidate profiles from the potential candidate list. The candidate profiles may be retrieved from the candidate profile database 202. The school requirements may be retrieved from the school profile database 206.

Each candidate included in the potential candidate is associated with a candidate qualifier 226 for a particular school. A candidate qualifier identifies a natural progression of a candidate within the admission cycle of the school, for a particular course. The candidate qualifier indicates which stage of the admission cycle the candidate is currently in. For example, for an admission cycle, the typical qualifiers may be prospects, inquired, applied, admitted, enrolled, confirmed or any other such stage within the admission cycle. The candidate qualifier may be updated by a school administrator, or may be automatically updated by the candidate event tracking module 208.

The candidate event tracking module 208 tracks and analyzes a candidate activity with respect to multiple schools within the admission cycle progress tracker 110. The candidate event tracking module 110 receives a candidate activity from a candidate 130 and retrieves the candidate profile from the candidate profile database 202. In some embodiments, the candidate event may be tracked from a desired school's website, from an online education platform that displays the candidate activity, or from any other third party that may share the candidate activity information with the candidate event tracking module 208. The candidate event tracking module 110 further analyzes the candidate activity to determine the type of activity and the associated school for which the candidate activity was performed. For example, the candidate may have indicated an interest in a particular school by way of social media, or a candidate may have accepted an admission offer from a school for a particular course. Further, the candidate event tracking module 208 may retrieve a list of schools that matches the candidate's interest. For example, the candidate's profile may match particular types of school based on the candidate's interest, major and demographic, the candidate may have applied to particular schools or the candidate may have received offers for admissions from particular schools.

Further, the candidate event tracking module 208 determines the current time point of the admission cycle of the school. For example, most of the schools may be at an enrollment time frame of the admission cycle, i.e. the schools may have sent admission offers to the candidates and are waiting on receiving acceptance from the candidates for enrolling to a particular course at the school. Based on the candidate activity of accepting an admission offer at a particular school, and the current time point of the admission cycle of the other schools, the candidate event tracking module 208 may determine that the candidate has progressed towards enrollment to that particular school. As a result, the candidate event tracking module 208 may update the candidate qualifier of the candidate, to indicate advancement, from “admitted” to “enrolled” for that particular school. In addition to updating the candidate qualifier for that particular school, the candidate event tracking module 208 updates the candidate qualifier to indicate retraction of the candidate within the admission cycle of the other schools. The candidate event tracking module 208 informs the candidate rank module 210 of the updated candidate qualifier for a candidate at all the participating schools.

The candidate rank module 210 determines a rank of a candidate in the potential candidate list for a school. A candidate may be ranked based on a number of factors, such the school requirements for an upcoming class, the academic profile of a candidate, the demographics of a candidate, the candidate's recorded level of engagements or activities and other such factors. A candidate may be on the potential candidate list for more than one school. The candidate rank may differ from school to school based on the requirements of the school. For example, a school in San Jose, Calif. may prefer a candidate within 25 miles of the school and another school in Napa, Calif. may prefer a candidate within 30 miles of the school. Based on this requirement a candidate residing in San Jose, Calif. may be ranked higher on the potential candidate list of the first school (i.e., the San Jose school). The candidate may be ranked lower on the potential candidate list of the second school (i.e. the Napa school).

The candidate rank module 210 further updates the ranking of a candidate in the potential candidate lists of schools, that the candidate is listed on. Once an initial potential candidate list for a school is completely ranked, the candidate rank module 210 may update the ranking based on updates to the candidate qualifier of each candidate for a particular school. The candidate rank module 210 receives an updated candidate qualifier from the candidate event tracking module 208. Based on the updated candidate qualifier for a particular school, the candidate rank module 210 retrieves a list of schools that the candidate is listed on, and updates the candidate qualifier of the candidate for each school. For example, if the update candidate qualifier indicates that the candidate has accepted an admission offer at a particular school, the candidate rank module 210 may remove the candidate from the potential candidate list of other schools, or lower the ranking of the candidate on the potential candidate list of other schools.

In another example, upon receiving a candidate activity and an updated candidate qualifier, the candidate rank module 210 may consider updating the candidate rank based on recorded history of the candidate's activities. Each candidate activity from the historical data that indicates an engagement with a school may be weighted. Based on the weighted average of the candidate's activities, the candidate rank module 210 may update the candidate's ranking at the second school. For example, one or more candidates with similar academic records may have accepted offers at a first school. The candidates may still be open to accept offers from a different school, by cancelling their acceptance at the first school. To update their candidate rankings at the second school, in addition to the current candidate activity of accepting offer at the first school, the candidate rank module 210 may retrieve a history of engagement and activities of the candidates with one or more desired schools. If the history of candidate activities indicates that the first candidate is highly engaged with the second school, even though the candidate accepted an offer at the first school, the candidate's ranking within the first school may not be updated, or it may be pushed higher in the potential candidate list of the second school. In another example, the engagement activities of the two candidates may be compared and the rank of the candidate with higher engagement activities with desired schools may be updated in the potential candidate list of the schools.

### Admissions Cycle Time Line of a School

FIG. 3 explains in detail an admission cycle time line, according to an embodiment. The time line includes a time point T6 indicating a start of an admission cycle. At time point T6, a school may start looking for prospective students for a class. The school may send informational material related to courses offered at the school to the prospective students. At time point T5, the school may look into the number of inquiries it receives, based on the informational material that they sent out related to the school. Further at time point T4, the school may start looking into the number of applications received for a course for the specific year. Based on the school requirements to fill the class, for example, the number of seats available, the minimum grade point for the course, the academic background desired by the school, location of the school and other such factors, a school administrator may start analyzing the received applications. At any point between T6 to T3, the school may make a list of potential candidates and rank each candidate based on the school's requirements to fill up a class.

At some time between time point T4 and time point T3, the school administrator starts sending admits to applicants that match the school requirements for a class. At time point T3, the school starts determining the number of admitted students for a class. Based on the number of admits, the school may make further decisions for filling up a class, for example, if they need to close admissions for a class, or send more admits to applicants of a specific class, or send admits based on certain academic criteria for a class and other such decisions.

Based on the admission timeline of a school, the school may allow an admitted applicant to enroll for the course within a specific time period. For example, an applicant may enroll by accepting an admission offer. Between time points T2 and T1, a school receives enrollment information of the admitted students. The school then determines the number of enrolled students. At time point close to T1, if the number of enrolled students does not fill up the class, the school may make decisions such as sending out admits to students from the potential candidate list based on their ranking and based on the school requirements to fill up the class at point T1. For example, there may be 4 seats available to fill up a class and the school may require female applicants to fill up the 4 seats. The school administrator may look up the potential candidate list to find the first four top ranked candidates that match the requirement, and send them an admit letter. Between time T1 and T0, the school closes admissions by confirming enrollment of the admitted applicants. For example, an admitted applicant can confirm enrollment by depositing an enrollment fee.

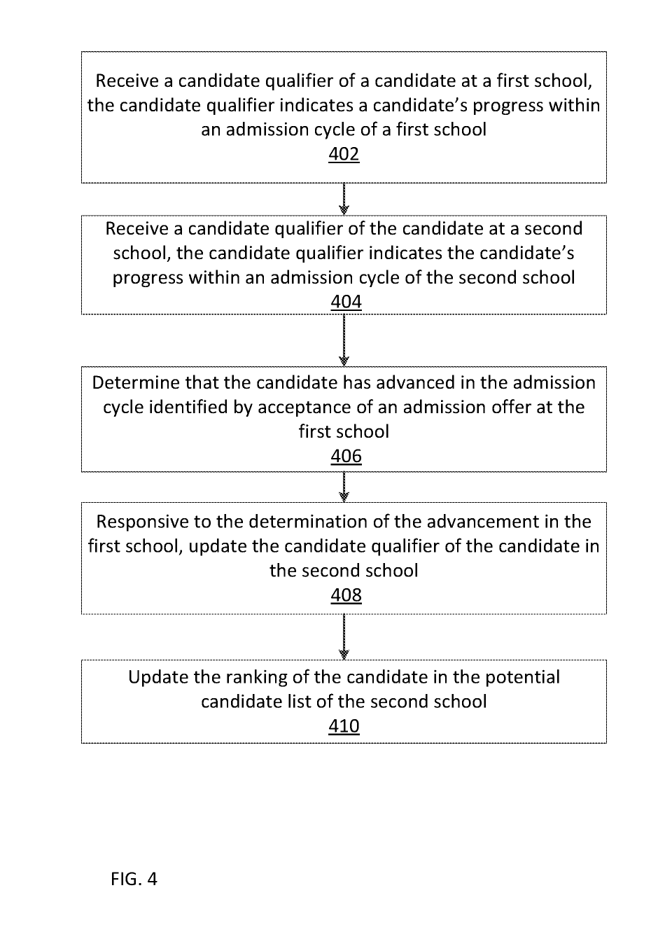

FIG. 4 is a flow chart illustrating the method for tracking a candidate's progress within admissions cycle of schools, according to one embodiment. An admission cycle progress tracker 110 receives 402 a candidate qualifier of a candidate on the potential candidate list of the first school. The candidate qualifier indicates the progression of the candidate within the admission cycle of the school. For example, a candidate qualifier “enrolled” indicates that the candidate has accepted an admission offer from the first school. The admission cycle progress tracker 110 further receives 404 a candidate qualifier of the same candidate from a second school, the candidate being on the potential candidate list of the second school. This candidate qualifier indicates the progression of the candidate within the admission cycle of the second school. For example, a candidate qualifier “admitted” indicates that the candidate has received an admission offer from the second school.

The admission cycle progress tracker 110 further determines 406, based on the candidate qualifier of the first school that the candidate has advanced in the admission cycle by accepting an admission offer from the first school. In addition to this determination, in one embodiment, the admission cycle progress tracker 110 may determine a current time point (stage) of the admission cycle at the schools. For example, the schools may between time points T3 and T2, i.e. admission stage. Responsive to determination of the advancement of the candidate in the admission cycle of the first school, the candidate qualifier of the candidate is updated 408 in the second school. For example, if a candidate qualifier at a first school is advanced to “admitted” at the first school, based on this advancement, the second school may send an admission offer and update the candidate qualifier of the same candidate to “admitted” at the second school. In another embodiment, based on the current time point in the admission cycle, the candidate qualifier at the second school may be updated at a later time point, for example, at the end of the enrollment stage in the admission cycle. Further, the admission cycle progress tracker 110 updates 410 the ranking of the candidate in the potential candidate list of the second school. For example, if the candidate accepted an admission offer at the first school, determined based on the candidate qualifier of the candidate at the first school, the candidate may be dropped from the potential candidate list of the second school. In another embodiment, in addition to the determination of advancement, the admission cycle stage is taken into consideration, based on the time point of the admission cycle, the candidate may be dropped from the potential candidate list of the second school, or in case the second school is still in the early stages of the admission cycle, the candidate ranking may be lowered in the potential candidate list of the second school.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for tracking progress of a candidate's admission, the method comprising:
receiving a candidate qualifier for a first school, wherein the candidate qualifier identifies a candidate's progress within an admission cycle of the first school;
receiving the candidate's qualifier for a second school, wherein the candidate qualifier identifies the candidate's progress within an admission cycle of the second school;
determining, based on the received candidate qualifier from the first school, an advancement of the candidate within the admission cycle of the first school, wherein the advancement is identified by a candidate activity that includes accepting an admission offer from the first school;
responsive to the determination of the advancement in the first school, updating the candidate qualifier of the candidate in the second school; and
updating a ranking of the candidate in a potential candidate list of the second school.

2. The method of claim 1, wherein updating the ranking of the candidate further includes dropping the candidate from the potential candidate list of the second school.

3. The method of claim 1, wherein updating the ranking of the candidate further includes moving the candidate to a ranking below its current ranking in the potential candidate list of the second school.

4. The method of claim 1, wherein updating the ranking of the candidate further includes determining a history of candidate activities for the candidate.

5. The method of claim 4, wherein updating the ranking of the candidate further includes moving the candidate to a ranking above its current ranking in the potential candidate list of the second school based on the history of candidate activities of the candidate.

6. The method of claim 1, further including determining a current time point of an admission cycle for a school to determine updating the ranking of the candidate within the potential candidate list of the second school.

7. A computer program product for producing ranked candidate leads, the computer program product comprising a computer-readable storage medium containing computer program code for:
receiving a candidate qualifier for a first school, wherein the candidate qualifier identifies a candidate's progress within an admission cycle of the first school;
receiving the candidate's qualifier for a second school, wherein the candidate qualifier identifies the candidate's progress within an admission cycle of the second school;
determining, based on the received candidate qualifier from the first school, an advancement of the candidate within the admission cycle of the first school, wherein the advancement is identified by a candidate activity that includes accepting an admission offer from the first school;
responsive to the determination of the advancement in the first school, updating the candidate qualifier of the candidate in the second school; and
updating a ranking of the candidate in a potential candidate list of the second school.

8. The computer program product of claim 7, wherein updating the ranking of the candidate further includes dropping the candidate from the potential candidate list of the second school.

9. The computer program product of claim 7, wherein updating the ranking of the candidate further includes moving the candidate to a ranking below its current ranking in the potential candidate list of the second school.

10. The computer program product of claim 7, wherein updating the ranking of the candidate further includes determining a history of candidate activities for the candidate.

11. The computer program product of claim 10, wherein updating the ranking of the candidate further includes moving the candidate to a ranking above its current ranking in the potential candidate list of the second school based on the history of candidate activities of the candidate.

12. The computer program product of claim 7, further including determining a current time point of an admission cycle for a school to determine updating the ranking of the candidate within the potential candidate list of the second school.

13. An admission cycle progress tracking system for updating candidate rankings, the system configured to:
receive a candidate qualifier for a first school, wherein the candidate qualifier identifies a candidate's progress within an admission cycle of the first school;
receive the candidate's qualifier for a second school, wherein the candidate qualifier identifies the candidate's progress within an admission cycle of the second school;
determine, based on the received candidate qualifier from the first school, an advancement of the candidate within the admission cycle of the first school, wherein the advancement is identified by a candidate activity that includes accepting an admission offer from the first school;
responsive to the determination of the advancement in the first school, update the candidate qualifier of the candidate in the second school; and
update a ranking of the candidate in a potential candidate list of the second school.

14. The system of claim 13, wherein updating the ranking of the candidate further includes dropping the candidate from the potential candidate list of the second school.

15. The system of claim 13, wherein updating the ranking of the candidate further includes moving the candidate to a ranking below its current ranking in the potential candidate list of the second school.

16. The system of claim 13, wherein updating the ranking of the candidate further includes determining a history of candidate activities for the candidate.

17. The system of claim 16, wherein updating the ranking of the candidate further includes moving the candidate to a ranking above its current ranking in the potential candidate list of the second school based on the history of candidate activities of the candidate.

18. The system of claim 13, further including determining a current time point of an admission cycle for a school to determine updating the ranking of the candidate within the potential candidate list of the second school.
